(19) United States
(12) Patent Application Publication
(10) Pub. No.: US 2004/0173411 A1
(43) Pub. Date: Sep. 9, 2004

(54) Elevator

(75) Inventors: Gert Silberhorn, Kuessnacht a. Rigi (CH); Peter Spiess, Meggen (CH); Ernst Ach, Ebikon (CH)

Correspondence Address: OSTROLENK FABER GERB & SOFFEN, 1180 AVENUE OF THE AMERICAS, NEW YORK, NY, 100368403

(73) Assignee: Inventio AG

(21) Appl. No.: 10/793,445

(22) Filed: Mar. 4, 2004

(30) Foreign Application Priority Data
Mar. 6, 2003 (EP) 03405156.5

(51) Int. Cl. B66B 1/34

(52) U.S. Cl. 187/277

(57) ABSTRACT

An elevator having deflecting rollers integrated in the cage floor or in the counterweight. The support and drive element is guided in the cage floor through a floor channel. By comparison with a conventional cage floor with deflecting rollers (bottom blocks) arranged underneath the cage floor, the cage floor is constructed to be very small in height overall, which has a direct effect on the shaft pit depth. The height gained by the cage floor can be saved in the shaft pit depth.

### BACKGROUND OF THE INVENTION

The present invention relates to an elevator consisting of an elevator cage movable in an elevator shaft, and a counterweight. The elevator cage and the counterweight are connected by means of a support and drive means guided over deflecting rollers. A drive drives the elevator cage and the counterweight.

An elevator installation is known from European reference EP 01811132.8, in which an elevator cage and a counterweight are movable in an elevator shaft along guide rails. The elevator cage and the counterweight are connected by means of a belt, wherein a 2:1 belt guide with underlooping of the elevator cage is provided. The belt ends are each arranged at an upper end of a guide rail. The belt is guided by way of two deflecting rollers arranged underneath the elevator cage and supports the elevator cage, by way of a drive roller of a drive arranged at the upper end of a guide rail and by way of a deflecting roller supports the counterweight. The guide rails supporting the elevator cage, the counterweight and the drive introduce the vertical forces into the shaft pit.

A disadvantage of the known equipment resides in the fact that the deflecting rollers arranged outside the elevator cage or the counterweight oblige a larger shaft height, a larger shaft width and a deeper shaft pit.

### SUMMARY OF THE INVENTION

Accordingly, it is an object of the present invention to provide an elevator installation that avoids the disadvantages of the known equipment and is constructed to be smaller.

Pursuant to this object, and others which will become apparent hereafter, one aspect of the present invention resides in an elevator having an elevator shaft, an elevator cage movable in the elevator shaft, and having a floor and a roof, and a counterweight. A support and drive means is arranged to connect the elevator cage with the counterweight. Deflecting rollers are integrated in either the floor or the roof of the elevator cage between two plates. A support and drive means is guided over the deflecting rollers and is driven by a drive so as to drive the cage and the counterweight.

In another embodiment of the invention, the deflecting rollers are integrated in the floor and the support and drive means is guided in a channel in the floor.

In still another embodiment of the invention, the deflecting rollers are integrated in the roof and the support and drive means is guided in a channel in the roof.

In still a further embodiment of the invention, elements are provided for supporting the deflecting rollers. The support elements are connected with either the cage floor or the cage roof. The floor or roof to which the elements are connected is of a sandwich construction.

In another embodiment of the invention, additional deflecting rollers are integrated into the counterweight. The counterweight has a cut out for receiving the additional deflecting rollers.

The counterweight is provided with an offset in a further embodiment of the invention, which off set is configured so that the counterweight can move past the drive.

The advantages achieved by the invention are essentially to be seen in that the elevator cage as well as the counterweight can be constructed to be more compact. By integration of the deflecting rollers in the elevator cage or in the counterweight, the shaft height, shaft width and pit depth can be dimensioned to be smaller. The cogged belt employed as support and drive means allows small bending radii and thus small diameters for the deflecting rollers and the drive wheels. Moreover, the cogged belt is disposed in mechanically positive connection with the drive wheels of the mechanical linear drive and with the deflecting rollers provided with a brake. A mechanically positive connection of the drive and support means with the drive wheels or with the brake rollers enables a lightweight mode of construction of the elevator cage. In particular, the cage floor or the cage roof with the integrated deflecting rollers can be realized by a stiff sandwich mode of construction capable of bearing loads. By comparison with a conventional cage floor with deflecting rollers (bottom blocks) arranged underneath, the cage floor of the present invention is constructed to be very small in height, which has a direct effect on the shaft pit depth. The height gained by the cage floor can be saved in the shaft pit depth. Moreover, the belt can be guided near the cage wall, which in turn has a favorable effect on shaft width. By comparison with a conventional cage roof with deflecting rollers (top blocks) arranged at the top the cage roof of the present invention can be constructed to be very small in height, which has a direct effect on the shaft head height. The height gained by the cage roof can be saved in the shaft head height.

For a more complete understanding of the elevator of the present invention, reference is made to the following detailed description and accompanying drawings in which the presently preferred embodiments of the invention are illustrated by way of example. That the invention may be embodied in several forms without departing from the spirit or essential characteristics thereof, it is expressly understood that the drawings are for purposes of illustration and description only, and are not intended as a definition of the limits of the invention. Throughout the following description and drawings, identical reference numbers refer to the same component throughout the several views.

### BRIEF DESCRIPTION OF THE DRAWINGS

FIG. 1 shows an elevator with deflecting rollers integrated in the floor of the elevator cage;

FIG. 1a shows a cage floor without a centrally arranged profile roller;

FIGS. 2, 3 and 4 show different arrangements of the deflecting rollers in the cage floor;

FIGS. 5 and 6 show a deflecting roller arranged at the guide center of the elevator cage;

FIGS. 7 and 8 show a deflecting roller arranged outside the guide center of the elevator cage;

FIGS. 9 and 10 show a counterweight with integrated deflecting rollers; and

FIG. 11 shows an elevator with deflecting rollers integrated in the roof of the elevator cage.

### DETAILED DESCRIPTION OF THE INVENTION

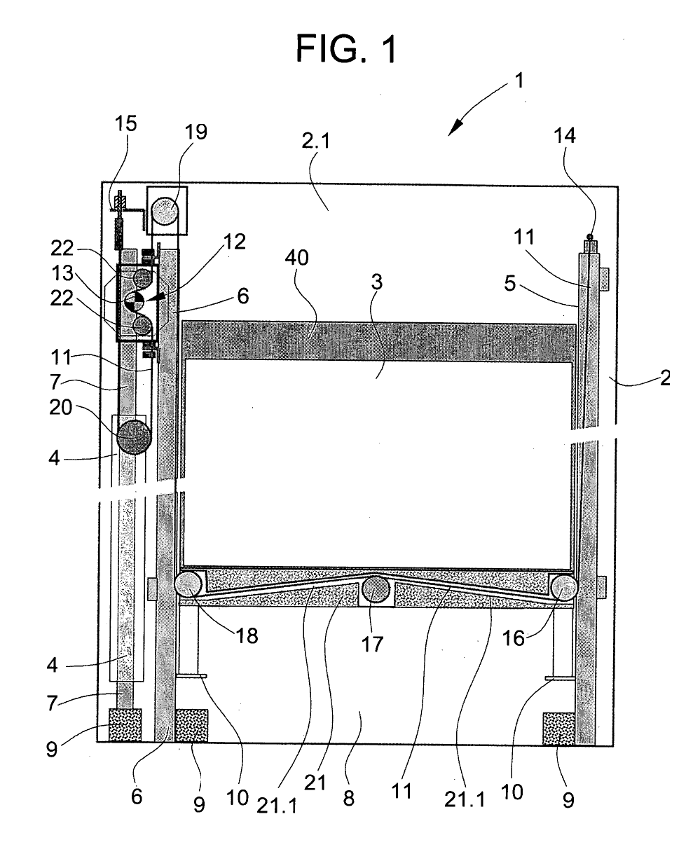

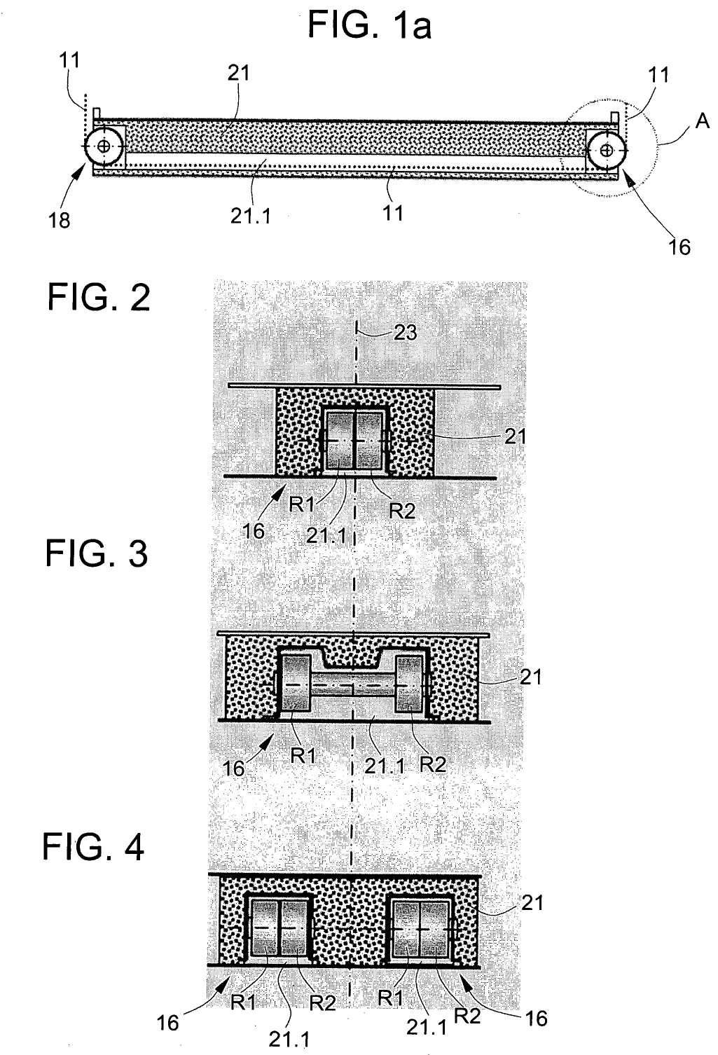

An elevator, which consists of an elevator cage 3 movable in an elevator shaft 2 and a counterweight 4 and which is denoted by 1, is illustrated in FIG. 1. The elevator cage 3 is guided by means of a first guide rail 5 and by means of a second guide rail 6. The counterweight 4 is guided by means of a third guide rail 7 and by means of a fourth guide rail, which is not illustrated. The guide rails are supported in a shaft pit 8, wherein the vertical forces are conducted into the shaft pit 8. The guide rails 5, 6 and 7 are connected with the shaft wall by brackets, which are not illustrated. Buffers 9, on which buffer plates 10 of the elevator cage 3 or the counterweight 4 can be placed, are arranged in the shaft pit 8.

A belt 11, for example a cogged belt, with a 2:1 belt guidance is provided as support and drive means. When a mechanical linear drive 12, which is arranged at the second guide rail 6, for example in the shaft head 2.1, advances the belt 11 by means of a drive wheel 13 through one unit, the elevator cage 3 or the counterweight 4 moves through a half unit. One end of the belt 11 is arranged at a first cable fixing point 14 and the second end of the belt 11 is arranged at a second cable fixing point 15. The belt 11 is guided over a first deflecting roller 16, over a profiled roller 17, over a second deflecting roller 18, over a third deflecting roller 19, over the drive wheel 13 and over a fourth deflecting roller 20. The first deflecting roller 16, the second deflecting roller 18 and the profiled roller 17 are integrated in the floor 21 of the elevator cage 3, wherein the belt runs in a floor channel 21.1. As in the embodiment of FIG. 1a, the profiled roller 17 can be omitted. The profiled roller 17 has a toothing corresponding with the toothing of the belt 11. The first deflecting roller 16 and the second deflecting roller 18 guide the belt 11 on the untoothed side by means of flanges arranged at the end faces of the rollers. The third deflecting roller 19 arranged at the second guide rail 6 is disposed by its toothing in engagement with the toothed side of the belt 11 and comprises a brake for normal operation. The drive wheel 13 is disposed by its toothing in engagement with the toothed side of the belt 11. Diverting rollers 22 of the linear drive 12 increase the angle of looping of the belt 11 at the drive wheel 13. The motor or motors for the drive wheel 13 is or are not illustrated. The fourth deflecting roller 20 is arranged in the counterweight and is comparable in construction with the first deflecting roller 16 or with the second deflecting roller 18.

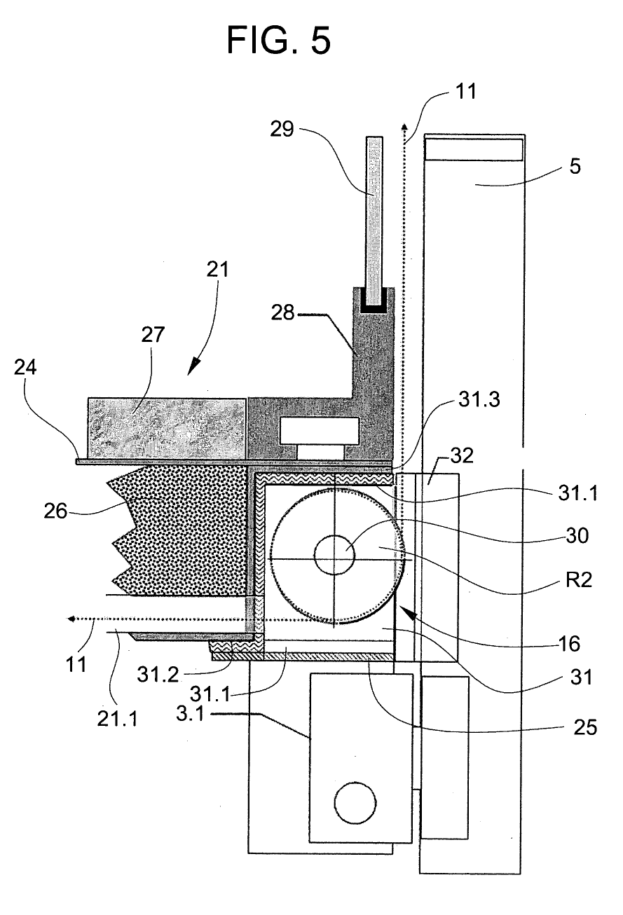

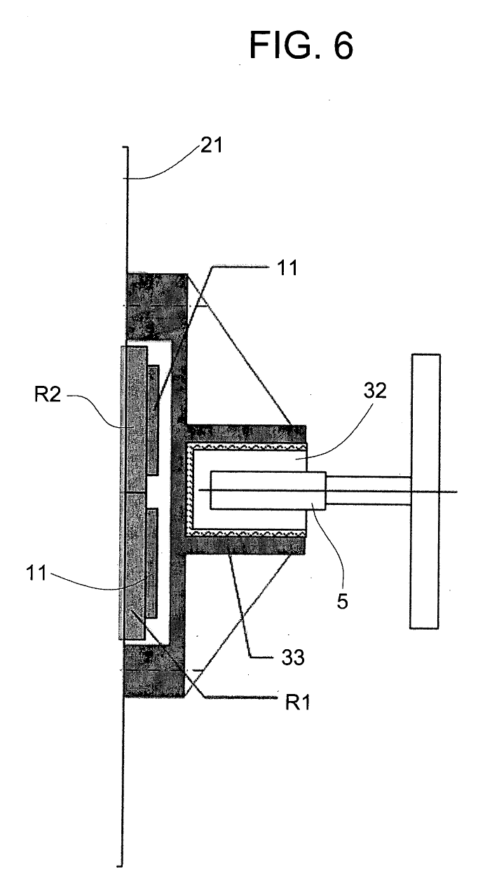

FIG. 2, FIG. 3 and FIG. 4 show different arrangements of the deflecting rollers 16, 18 in the cage floor 21 in the region of the guide center 23 of the elevator cage 3. FIG. 2 shows the deflecting rollers 16, 18, which are arranged behind the guide rails 5, 6, with a first roller R1 and a second roller R2, wherein each roller is provided with a belt 11. The rollers R1, R2 are independent of one another and are free-running. The belts 11 run behind the guide shoe. Details with respect to these variants are illustrated in FIG. 5 and FIG. 6.

FIG. 3 shows rollers R1, R2 disposed outside the guide rails 5, 6. The belts 11 run behind the guide shoe. The roller spacing determines the belt spacing and thus the spacing of the drive wheels 13 and the length of the mechanical linear drive 12.

FIG. 4 shows doubly executed deflecting rollers 16, 18, which are comparable in construction with FIG. 2, with rollers R1, R2 disposed outside the guide rails 5, 6. This arrangement for four belts 11 is provided for larger support forces.

FIG. 5 and FIG. 6 show the detail A of FIG. 1a with a first deflecting roller 16 arranged at the guide center 23 of the elevator cage 3. FIGS. 5 and 6 are also applicable in the same sense for the second deflecting roller 18. The section of the cage floor 21 is taken through the guide center 23. The cage floor 21 constructed in sandwich mode of construction consists of a roof plate 24 and of a floor plate 25, between which a foam filling 26 is arranged, wherein the floor channel 21.1 for the belt 11 is cut out. The roof plate 24 supports a floor covering 27 and, in the edge regions, a base profile member 28 on which wall elements 29 can be placed. In the corners of the cage floor 21 the base profile 28 is connected by means of rods, which are not illustrated, with the cage roof, which is not illustrated. The rollers R1, R2 are arranged to be free running on an axle 30, wherein the axle 30 is mounted in a base 31. The base 31 is connected with the floor plate 25 and the roof plate 24, and consists of a support element 31.1, an insulating element 31.2 and a top element 31.3. A safety brake device 3.1, which stops the elevator cage 3 in the case of emergency, is arranged underneath the deflecting roller 16. As shown in FIG. 6, the deflecting roller 16 is arranged below a bracket supporting a guide shoe 32, wherein there is still place for the belts 11 between the bracket 33 and the rollers R1, R2.

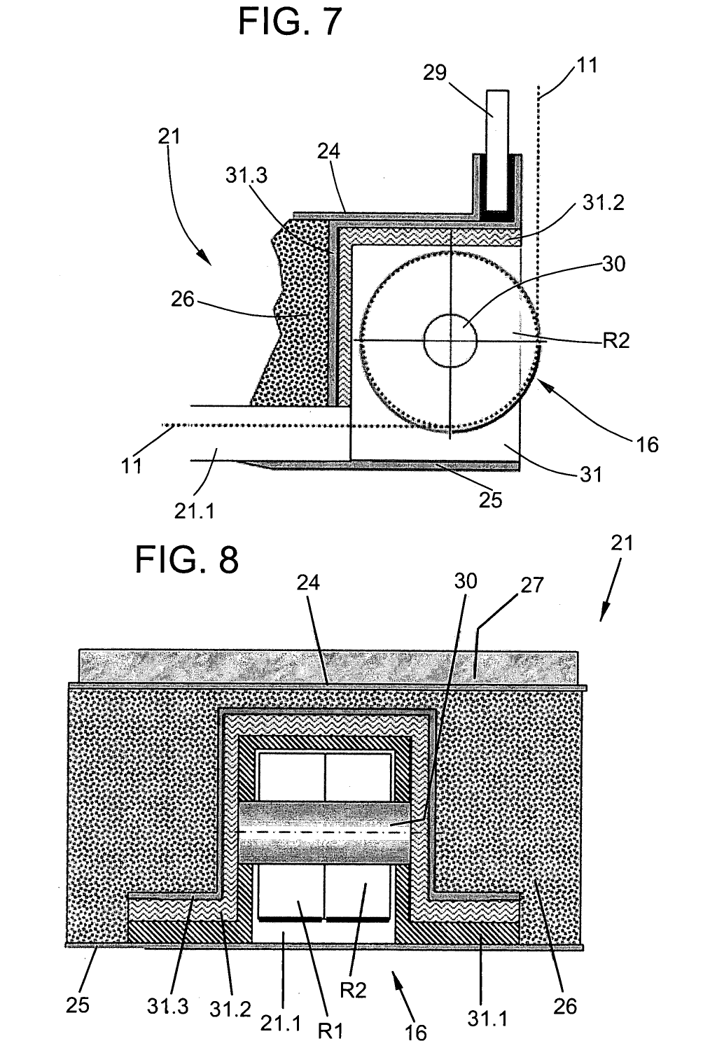

FIG. 7 and FIG. 8 show the detail A of FIG. 1a with first deflecting rollers 16, which are arranged outside the guide center 23 of the elevator cage 3, according to FIG. 4. FIGS. 7 and 8 are applicable in the same sense for the second deflecting rollers 18. The construction and arrangement in the cage floor 21 of the deflecting roller 16 is comparable with the embodiments according to FIGS. 5 and 6.

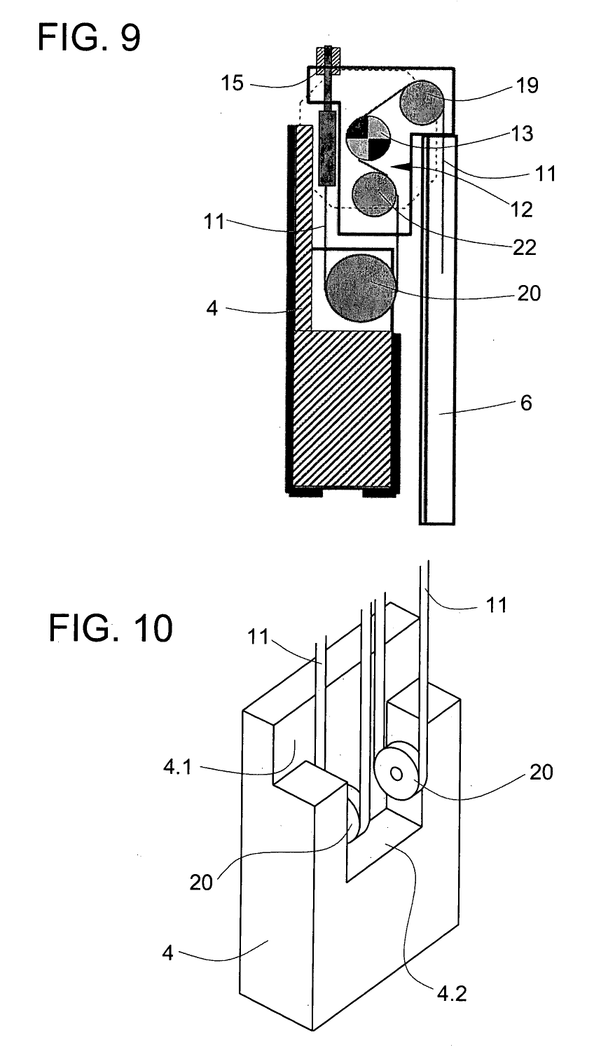

FIG. 9 and FIG. 10 show a counterweight 4 with integrated deflecting rollers 20. In the upper region the counterweight 4 has an offset 4.1, wherein the offset 4.1 is so dimensioned that the counterweight 4 can move past the mechanical linear drive 12. Moreover, a cut-out 4.2, in which the deflecting rollers 20 are integrated, is arranged at the counterweight 4. With the offset 4.1 in the counterweight 4 and the deflecting rollers 20 integrated in the cut-out 4.2 the shaft height or the shaft head height can be fully utilized.

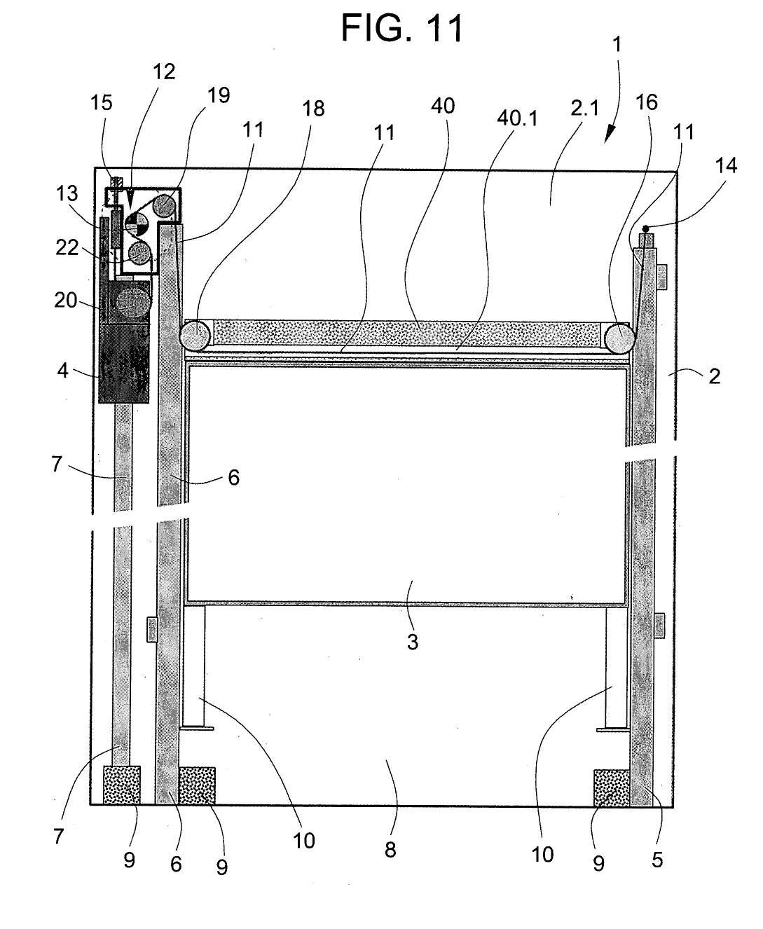

FIG. 11 shows an elevator with deflecting rollers 16, 18 integrated in the roof 40 of the elevator cage 3. The mechanical linear drive 12 and the counterweight 4 are constructed according to FIGS. 9 and 10. The roof 40 of the elevator cage 3 has a roof channel 40.1 in which the belt 11, which serves as support and drive means, is guided. The arrangement of the deflecting rollers 16, 18 is in the same sense as FIGS. 1a to 8.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. An elevator, comprising: an elevator shaft; an elevator cage movable in a shaft and having a floor and a roof; a counterweight; support and drive means arranged to connect the elevator cage and the counterweight; deflecting rollers integrated in one of the floor and the roof of the elevator cage between two plates, the support and drive means being guided over the deflecting rollers; and a drive operative to drive the elevator and the counterweight via the support and drive means.

2. The elevator according to claim 1, wherein the deflecting rollers are integrated in the floor of the elevator cage and the support and drive means is guided in a channel in the floor.

3. The elevator according to claim 1, wherein the deflecting rollers are integrated in the roof of the elevator cage and the support and drive means is guided in a channel in the roof.

4. The elevator according to claim 1, and further comprising elements that support the deflecting rollers, the support elements are connected with one of the cage floor and the cage roof.

5. The elevator according to claim 4, wherein the cage floor has a sandwich construction.

6. The elevator according to claim 4, wherein the cage roof has a sandwich construction.

7. The elevator according to claim 1, and further comprising additional deflecting rollers integrated in the counterweight, the counterweight having a cut-out for reception of the additional deflecting rollers.

8. The elevator according to claim 7, wherein the counterweight has an offset configured so that the counterweight can move past the drive by the offset.
